(19) United States
(12) Patent Application Publication
(10) Pub. No.: US 2024/0061415 A1
(43) Pub. Date: Feb. 22, 2024

(54) SYSTEM AND METHOD FOR TESTING A PROCESS CHAIN IN AN INDUSTRIAL ENVIRONMENT

(71) Applicant: VEGA Grieshaber KG, Wolfach (DE)

(72) Inventors: Clemens Hengstler, Haslach (DE); Stefen Kaspar, Hofstetten (DE)

(21) Appl. No.: 18/450,526

(22) Filed: Aug. 16, 2023

(30) Foreign Application Priority Data
Aug. 17, 2022 (DE) 10 2022 120 744.7

(51) Int. Cl. G05B 23/02

(52) U.S. Cl. CPC G05B 23/0264; G05B 23/027

(57) ABSTRACT

A system for testing a process chain in an industrial environment, wherein the process chain has at least one field device, comprises a control unit and a mobile terminal device. The control unit communicates with and controls the at least one field device during a testing process and/or read out of data. The mobile terminal device has at least one recording device configured for recording a behavior of at least a part of the process chain, and the mobile terminal device is configured for generating, from information recorded by the at least one recording device, a log record of the at least one part of the process chain and storing the log record.

### CROSS REFERENCE TO RELATED APPLICATIONS

This application claims priority to German Application No. DE 10 2022 120 744.7 filed Aug. 17, 2022, which is hereby incorporated by reference in its entirety.

### FIELD OF THE INVENTION

The invention relates to a system and a method for testing a process chain in an industrial environment, wherein the process chain comprises at least one field device.

### BACKGROUND OF THE INVENTION

Various field devices are used in an industrial environment, particularly in process automation. These field devices may include measuring devices and/or actuators. Measuring devices may be configured, for example, for measuring a filling level, a limit level, a pressure, a temperature and/or other physical quantity. Actuators may include, for example, valves, pumps, electric motors and/or other devices influencing the process chain.

Most frequently, such field devices are used in process chains in which different actuators, measuring devices, signaling devices and/or other components cooperate. In this case, the individual components of a process chain should work together smoothly. This is of importance particularly in the case of safety-critical systems. In order to avoid safety-critical states, a process chain should react reliably and correctly to different basic conditions and influencing parameters.

For testing a correct interaction of the components of a process chain, or generally for testing a process chain, it is customary to influence the process chain in a testing process in a predetermined manner and compare measurement values and/or other outputs of the field device/devices of the process chain with a desired behavior. This may entail that at a certain point in time during the testing process, a recorded measurement value is within a desired range, a desired signal tone is output or another desired state of the process chain is attained and/or is recorded. In safety-critical systems, such testing processes are usually prescribed in regular intervals, e.g. by the Water Resources Act (Wasserhaushaltsgesetz, WHG) or IEC 61508/IEC 61511 for compliance with a safety integrity level (SIL).

The execution of such testing processes requires specially trained personnel which knows well the steps to be initiated and the behavior to be expected in each case and carry out the tests in an experienced manner and regularly. For supporting them, software-based systems are known, which guide the testing person through the testing process step by step. Thus, a correct test is possible also for persons that only received a comparatively short instruction with regard to testing and/or rarely carry out such tests. Nevertheless, such software-based testing processes are also susceptible to errors because a correct behavior of the process chain is frequently complex and difficult to recognize, and nuances are hard to perceive for persons with little experience. In unfavorable cases, this may result in existing or imminent problems being overlooked.

### SUMMARY OF THE INVENTION

It is an object of the invention to provide a system and a method with which a test of the process chain can be reliably and precisely carried out in an industrial environment. In this case, it is advantageous if operators require no comprehensive training courses and the procurement of expensive equipment is avoided.

This object is achieved by the combinations of features of the independent claims. Other embodiments and developments are disclosed by the respective dependent claims.

It should be noted that the features cited individually in the claims can be combined with each other in any technologically meaningful manner (also across the boundaries of categories, such as method and device) and represent other embodiments of the invention. The description, in particular in connection with the Figures, additionally characterizes and specifies the invention.

It is also noted that a conjunction “and/or” used hereinafter, which is situated between two features and links them to each other, should always be interpreted such that, in a first embodiment, only the first feature may be provided, in a second embodiment, only the second feature may be provided, and in a third embodiment, both the first and the second feature may be provided.

The present disclosure utilizes a control unit and a mobile terminal device for carrying out the test of the process chain. The control unit can be connected via a communication interface to the at least one field device of the process chain. Via this communication interface, or a connection to the at least one field device established thereby, the control unit can control the at least one field device during a testing process and/or read out data from the at least one field device. Which of these functions is required for which field device at which point in time, may most frequently depend on the testing process, the process chain, the respective field device, and other boundary conditions. Thus, reading out data may be the priority in the case of a field device comprising a sensor. Nevertheless, controlling may also be required, e.g. by parameterizing a measuring process or by triggering a measurement. In the case of a field device comprising an actuator, the controlling of the field device may be the priority. Nevertheless, such a field device may also be additionally configured for recording a state, and data describing the state can be read out. Thus, the position of an actuating element of the actuator can be recorded and outputted, for instance. These examples are supposed to illustrate that, at least in some cases, both a reading-out of data and a controlling of the field device may be utilized.

The terminal device used in the system has one or several recording devices which is/are configured for recording the behavior of at least a part of the process chain. For the present disclosure, various terminal devices and various recording devices can be used. In particular, terminal devices can be used that have a universal configuration and were given the capability of being used in the system disclosed herein by means of suitable software. This may avoid the procurement of expensive equipment. The terminal device used should be configured to record information about the process chain by means of the at least one recording device during the testing process and, based on this recorded information, to generate and store a log record.

In this way, not only can a reliable and precise control of the testing process be attained by the system disclosed herein or the method disclosed herein, but the behavior of the process chain can be recorded during the testing process by means of the log records. By suitably evaluating the log records, imminent errors or deviations from a nominal behavior of the process chain can become more easily and reliably recognizable. Moreover, the log records additionally permit the testing process to be documented, whereby the behavior of the process chain during the testing process can be demonstrated and/or traced in case of future questions. Depending on the configuration of the system, this may reach the level of test reports suitable for submission to courts.

The system and method disclosed herein can be used for testing a process chain in an industrial environment. Such process chains may be employed in automation technology, for instance. An “industrial environment” may have different forms. For example, reference is made here to plants in the chemical, food, pharma, energy, paper, water/wastewater, building material, shipping, mining, or petrochemical sectors. Depending on the site of a process chain, the components of a process chain may differ.

A “process chain” may comprise various components that cooperate for carrying out one or several tasks in the industrial environment. This may mean that the state of a component of the process chain may affect the state of another component of the process chain, wherein such process chains most frequently have a main direction of action. The components of a process chain may include field devices, output devices (e.g. displays and loudspeakers), warning and signaling devices (e.g. horns, buzzers or warning lights), input devices (e.g. keys, keyboards or touchscreens), etc., to mention but a few conceivable components as examples.

A “field device” may comprise a “measuring device” and/or an “actuator”. A “measuring device” is generally configured for recording physical quantities. Such a physical quantity may include a filling level, a limit level, a pressure, a temperature, a flow quantity, a flow rate, a humidity, a distance, a frequency, a light intensity, a spectrum, a pH value etc., to mention but a few conceivable examples that are not to be considered to be limiting.

An “actuator” may, in principle, be anything that acts on the process chain. This may include an active intervention in the process chain. In what manner this action specifically takes place is not of pivotal importance. Such an actuator may comprise, for instance, a motor, a valve, a pump, a switch or the like, to mention but a few conceivable examples that are not to be considered limiting. Such actuators may also include sensors with which a state of the actuator can be recorded, e.g. a position sensor of a switch or an angle sensor for recording the rotational position of a valve.

An actuator is often controlled by a control and/or regulating device, wherein measurement values from measuring devices or the actuators themselves can be used for control/regulation. In order to be used with the system disclosed herein, these control/regulating devices may have corresponding control inputs and be controlled by the control unit of the system during the testing process.

A “testing process”, during which the at least one field device is controlled by the control unit, may also include a wide variety of things. Generally, a testing process includes a sequence of steps within the process chain, which is characterized by measurement values and/or control commands and an associated nominal behavior of the process chain and/or its components. In this case, it may be an option if the testing process is capable of making a cause-and-effect relation between the individual components of the process chain examinable and traceable. A step in the testing process may comprise, for example, overfilling a container, letting a container run dry, reaching a process pressure that is too high/too low, putting an additional load on a pump or electric motor, introducing a mechanical load (e.g. a strike or impact), or stopping a fan, to mention but a few possible testing steps as an example, but not in a limiting manner. In this case, the respective states can be induced in a targeted manner, e.g. by an overfilling or running-dry of a container being provoked in a targeted manner, for example. However, it is also conceivable that these states are being simulated. In this case, a sensor may be exposed directly, e.g. by a sensing element of the sensor being immersed in a container filled with filling material, thus simulating a critically high filling level being reached. Another conceivable option is that the sensor is caused to output a corresponding measurement value or that a corresponding measurement value is fed into the process chain in another manner.

The “control unit” may have various configurations and control the testing process in different ways. As was already mentioned, a communication interface may be provided for this purpose, via which the control unit can act on control/regulating devices of the process chain and/or on the at least one field device. However, it is also conceivable that the control unit is capable of outputting instructions to a user, thus influencing the testing process only in an indirect fashion.

In principle, the “communication interface” may have many different configurations as long as communication between the control unit and the at least one field device can be made possible via this communication interface. In this case, several communication interfaces may also be provided and used in parallel, wherein some of the field devices may be addressed by one of the communication interfaces and some of the field devices may be addressed by a different one of the communication interfaces. The communication interface may be configured for short-range communication (e.g. for local distances of up to 10 centimeters, up to 10 meters, up to 25 meters, or up to a few hundred meters) or for wide area communication (e.g. for local distances in the range of kilometers or more). In one configuration, the communication interface may have a wired configuration. As an example, reference may be made here to 4 . . . 20 mA/HART, Ethernet, Profibus, Foundation Fieldbus, Profisafe, relay contact, transistor output, NAMUR output or the like. In another configuration, the communication interface may have a wireless configuration, with both radio-based and optical technologies being conceivable. As an example for usable wireless interfaces, reference may be made to Bluetooth, Bluetooth LE, WLAN, NFC, LTE, LTE-M, LoRaWAN, NB-IoT/4G or 5G.

The “mobile terminal device” may also be formed by various devices. In order to reduce costs, one option is if the mobile terminal device is as universal as device as possible, which is given the capability of being used in the system or method disclosed herein by means of suitable software. Exemplary embodiments of such mobile terminal devices include a smartphone, laptop, or netbook. In principle, less mobile terminal devices may also be used, such as a personal computer, for instance. Such mobile terminal devices most frequently comprise at least one processor, a storage unit (e.g. RAM—Random Access Memory—, Flash or hard disk), input and output devices, communication modules and other devices whose function and interaction is controlled by an operating system. Microsoft Windows, Android, iOS, iPadOS, or Linux may be used as such an operating system. The function of the mobile terminal device within the system or method disclosed herein can be attained by one or several programs/apps.

In principle, a “recording device” may be anything that is capable or recording and depicting a behavior of a process chain. In this case, several recording devices can be used, which record different behaviors of the process chain at different times and/or different locations of the process chain. Thus, a camera can record optical information about the process chain, e.g. a movement of an actuating element or valve, a warning light lighting up, a limit level being reached, a switching of a relay, an opening of a door or a start-up of a fan. A microphone can record acoustic information about the process chain, e.g. the sound of a pump, of a bearing, of a solenoid valve or of an electric motor, the tone of a buzzer or a vibration after an impact. These few examples, which are not to be considered to be complete or limiting, show how universal the at least one recording device may be configured. At the same time, a recording device may also be used for recording several things within the process chain. In this case, the respective recording device and its use may be adapted to the things to be recorded in each case.

Accordingly, a “log record” may also be dependent on the respective recording device. If optical information is recorded, one option is that the log record contains an image, a sequence of images or a video. If acoustic information is recorded, the log record may contain an audio file. Combinations are also conceivable, e.g. a video with an audio track. A log record may also include a certain evaluation of recorded raw data, e.g. a spectrum, a course over time of an intensity, an amplitude of an oscillation (e.g. of a first harmonic) or a signal-to-noise ratio.

Generally, a “log record” may characterize the recorded part of the process chain and/or its behavior at the time of the recording. Ideally, the log record should be suitable for enabling conclusions as to the state of the process chain or of individual components thereof. However, this requirement can usually be met easily. The goal may be to subject the log file to a detailed test, to enable a documentation of the testing process and/or to verify the testing process and its course.

The storage location at which a log record is stored may be configured in different ways. One option is to store the log record in a non-volatile storage unit, e.g. a hard disk, a flash memory or a solid-state disk. For this purpose, a temporary storage in a volatile storage unit, e.g. a RAM (Random Access Memory), may be appropriate or necessary. A log record may also be transferred into a cloud system and stored and/or evaluated further therein.

In one embodiment, the at least one recording device includes a camera, a microphone, a temperature sensor, a pressure sensor, a gravity sensor, a magnetic field sensor, a vibration sensor and/or other sensors. Various information from the process chain can be optically recorded with a camera, e.g. movements, visual warning lights, visual notifications or the like. Tones and noises can be recorded with a microphone, which reach the microphone via air-borne sound, e.g. a signaling tone of a buzzer, a warning tone of a horn, the clicking of a relay, the sound of an opening/closing valve or the sound of a working pump. Temperatures can be recorded with a temperature sensor, e.g. an ambient temperature of the process chain or a surface temperature of an electric motor of the process chain. The pressure sensor may record a pressure, e.g. an ambient pressure or a pressure in a part of the process chain. A gravity sensor can measure an attitude relative to gravity, e.g. the attitude of a component on which the gravity sensor rests. Alternatively, the attitude may also be identified in relation to another sensor, e.g. a camera, and the attitude in space output in this manner. This also applies, mutatis mutandis, to a magnetic field sensor, which can output a relative attitude relative to earth's magnetic field. A vibration sensor can record vibrations, for instance, whose frequencies are outside the audible range and/or are transmitted by structure-borne noise.

In one embodiment, the at least one recording device is integrated in the mobile terminal device or connected via a peripheral interface to the mobile terminal device. The utilization of integrated sensors offers the advantage that handling them is particularly easy because no wiring or coupling, for example, is required. Moreover, recording devices that are already provided in the terminal device can be used here. If a smartphone, for instance, is used as a mobile terminal device, the camera, microphone, gravity sensor, pressure sensor and sensor for earth's magnetic field of the smartphone can be used for the presently disclosed system. The utilization of recording devices connected via a peripheral interface increases flexibility, because different recording devices can be connected depending on the recording needs. In this way, oscillation sensors, external pressure sensors, light intensity sensors or spectrometers can be integrated into the system. In principle, a wide variety of interfaces can be used as peripheral interfaces. As an example, reference may be made in this connection to USB—Universal Serial Bus—, to the Lightning connector, Bluetooth or Bluetooth LE.

In one embodiment, the log record depicts at least an interval in time of the testing process. A depiction of the entire testing process offers a particularly good and detailed recording of the testing process. In order to reduce the generated data volume, however, it may be an option to cover only one or several intervals in time of the testing process by a log record. These intervals may cover “important” portions of the testing process. What an “important” portion is will depend on the respective process chain and the respective testing process. Such a portion may be, for example, the testing of a safety-critical sensor, the testing of an important safety chain, or the testing of a warning horn. By choosing suitably, an optimization between the recording level and the generated data volume can be attained.

The testing process may also be represented by several log records. The several log records may respectively relate to the testing process or a portion thereof and concern processes that run in parallel and/or are sequential. Thus, it is conceivable that a component of the process chain is recorded with a camera of the mobile terminal device while the sounds of another component of the process chain are recorded by a microphone of the mobile terminal device, and the intensity of emitted light with another recording device of the mobile terminal device. Each of these recording devices can generate separate log records, i.e. an image sequence from the camera, an audio recording from the microphone and a course over time from the further recording device, for example. In addition, one recording device may also generate several log records, particularly for the same component of the process chain and/or different components of the process chain.

In one embodiment, the system additionally comprises an evaluation unit, wherein the log record can be inputted into the evaluation unit and the evaluation unit is configured for evaluating an inputted log record. In this way, added value can be obtained from the log record. In this case, the evaluation unit can evaluate an inputted log record in various manners. Simple filtering tasks (e.g. high-pass, low-pass, band-pass filtering) or basic operations (e.g. determining an average, a maximum value, a minimum value or a square of an absolute value) can be carried out. Other, slightly more complex evaluations may include determining a spectrum, a fundamental oscillation or a resonant frequency. An evaluation may also include a pattern recognition in order to be able, for example, to recognize the correct recording of a certain area of the process chain. In other evaluations, it can be traced, for example, whether a recorded sound (e.g. a horn) actually originates from the source to be expected or whether there is a misclassification (e.g. a vehicle horn). For this purpose, the frequency of the recorded sound can be compared to a nominal frequency, for instance. These examples, which are not to be understood to be exhaustive or limiting, illustrate how comprehensive an evaluation can be carried out.

In one embodiment, the evaluation unit is configured for comparing an inputted log record with a log record of an earlier testing process and/or with a nominal course, and to issue a notification in case of a deviation beyond a threshold value. By comparing an inputted log record with a log record from an earlier testing process, changes within the process chain over time can be identified. The comparison to a nominal value lets the compliance with specifications become recognizable. In both cases, the comparison may result in a deviation measure, which leads to the outputting of a notification if a predetermined threshold value is exceeded. In this way, an imminent error and an unfavorable change can be recognized and—if necessary—a preemptive maintenance process can be triggered.

In one embodiment, the system additionally comprises a logging unit, wherein the logging unit is configured for generating a test log during the testing process based on control commands and/or measurement values of the at least one field device and/or their chronological order and/or the log record and/or based on other information. A documentation of the testing process can be automatically prepared by means of a logging unit. In one embodiment, the logging unit operates without any possibility of influencing it from the outside, so that a secure test log is created that cannot be manipulated. In principle, anything relevant for the testing process can be stored in the test log. The inclusion of control commands permits an overview over the processes during the testing process. The inclusion of measurement values provides an overview over the behavior of the process chain during the testing process. The inclusion of chronological orders, e.g. by sequential storing or the storing of time stamps, can make a causality between the different processes visible. The inclusion of the log records can provide even more detailed information on the behavior of the process chain during the testing process. The individual pieces of information may be stored in different manners. How the test log is constructed specifically is of minor importance for the present disclosure.

In one embodiment, the system additionally comprises a cloud system, wherein the mobile terminal device is connected in a communicating manner to the cloud system and is preferably configured to transmit the log record into the cloud system in order to store the log record. Using a cloud system permits a reliable and high-performance storage of the log records. In this way, the storage requirement in the mobile terminal device can be kept to a minimum. In addition, the data in the cloud system can be accessed more reliably by a third party and an even better protection against manipulation can be established. In this case, it makes sense if the cloud system can be reached via a predefined and standardized interface. In one embodiment, the “inclusion of a cloud system” may also mean that a cloud system is or can be connected to the system disclosed herein and resources of the cloud system can be used in the system disclosed herein.

In one embodiment, the evaluation unit is implemented in the cloud system. In this way, the resource requirements in the mobile terminal device can be reduced because, most frequently, a substantial computing power and storage capacities can be provided more easily in a cloud system.

In one embodiment, the control unit is implemented in the mobile terminal device. In this way, the testing process can substantially be controlled from the mobile terminal device. In this case, the control unit may be implemented by a program running on the mobile terminal device or by an app running on the mobile terminal device and access resources of the mobile terminal device.

In one embodiment the control unit is configured for setting and/or controlling a starting time for the recording by the at least one recording device and/or the duration of the recording. In this way, it is possible to determine by means of the control unit in which portion in time of the testing process a recording of components of the process chain is important and/or indicated. The relevant interval in time of the testing process can be determined by means of the starting time and the duration of the recording.

In one embodiment, the communication interface is formed by a wireless interface, preferably for a short-range communication or a wide area communication. By forming the communication interface with a wireless interface, a flexible connection between the field devices and the mobile terminal device can be established. A short-range communication offers a connection option for field devices at short range. A wide area communication makes it possible to communicate with field devices also across larger or large distances.

In one embodiment of the method, the log record is stored together with a time stamp and/or with measurement values of the at least one field device and/or with control information for the at least one field device and/or status information of the process chain. In this way, the results of the testing process can be stored in a reliable and ordered manner and provided for future use. This information may be stored in a test log, which can offer a comprehensive overview of the testing process.

In one embodiment, a computer program product is provided which can be executed on a mobile terminal device. This computer program product may generally be a software or software collection which can be processed by a mobile terminal device or its operating system using resources of the mobile terminal device. The computer program product may be configured for giving a mobile terminal device the capability of being used in a system according to the present disclosure and/or to execute a method according to the present disclosure. The computer program product may be provided on a storage medium, e.g. a USB stick or a CDROM, or also in a downloadable manner, e.g. from an app store.

### BRIEF DESCRIPTION OF THE DRAWINGS

Other advantages and features of the invention become apparent from the following description of exemplary embodiments, which shall be understood not to be limiting and which will be explained below with reference to the drawing. In this drawing, the Figures schematically show:

FIG. 1 shows a first exemplary embodiment of a system according to the present disclosure,

FIG. 2 shows a second exemplary embodiment of a system according to the present disclosure, and

FIG. 3 shows a flow chart of an exemplary embodiment of a method according to the present disclosure.

### DETAILED DESCRIPTION OF THE DRAWINGS

In the various figures, parts that are equivalent with respect to their function are always provided with the same reference numerals, so that they are also only described once, as a rule.

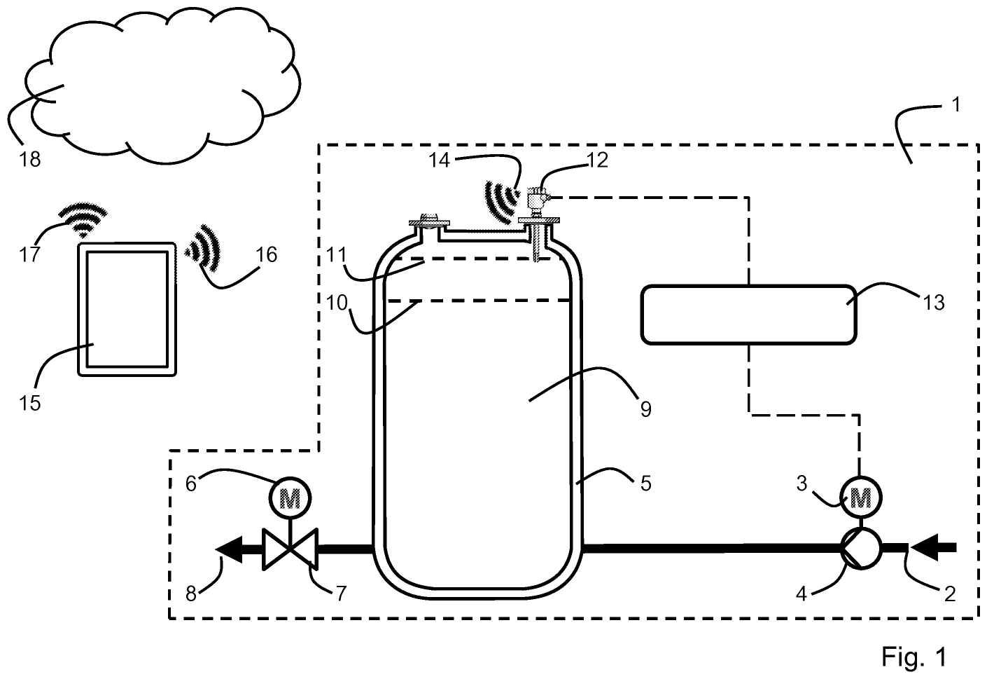

FIG. 1 shows a first exemplary embodiment of a system according to the present disclosure, with the focus of the illustration substantially being the process chain. A process chain 1 can be tested with the system according to FIG. 1. Despite the simplicity of the process chain 1, the fundamental mode of operation of the present disclosure becomes apparent. The process chain 1 comprises a intake pipe 2, a pump 4 driven with an electric motor 3, a container or tank 5, a valve 7 that is adjustable by means of an electric motor 6, and an outlet pipe 8. In the process chain 1, a filling material 9 (e.g. a liquid, bulk material or mixture/suspension) is conveyed by the pump 4 from the intake pipe 2 into the tank 5. The valve 7 influences the quantity of filling material 9 flowing away through the outlet pipe 8. In case of an ideal operation, a level of the filling material 9 around a nominal level 10 will be reached. If less filling material flows away through the outlet pipe 8 or more filling material is transported by the pump 4, a critical level 11 can be reached. A limit level sensor 12 records the critical level 11 being reached. Instead of the limit level sensor 12, a radar-based or optical filling level sensor may also be used, for example, with which a critically low level (not shown) can also be recorded. Alternatively or additionally, other and/or further measuring devices may be arranged in the process chain, which may be configured, for example, for measuring a pressure, a temperature and/or other physical quantity. A PLC control system 13 controls the electric motor 3 of the pump 4, inter alia using a measurement signal of the limit level sensor 12. When the critical level 11 is reached, the PLC control system 13 reduces the intake flow or turns off the electric motor 3 of the pump 4 completely, so that the filling level of the filling material 9 does not, or only slightly, exceed the critical level 11.

The limit level sensor 12 includes a radio interface via which the measurement values can be transmitted and adjustments can be made. The communication capability via radio is indicated by radio waves 14. In addition, it is conceivable that the two actuators formed by the electric motor 3 and the pump 4, and by the electric motor 6 and the valve 7, respectively, or the PLC control system 13 have a radio interface (not drawn in). A mobile terminal device 15 formed, for instance, by a laptop, a mobile phone or a tablet, has two radio interfaces: One radio interface 16 is designed for short-range communication and can form a communication interface for the system disclosed herein; another radio interface 17 is configured for wide area communication and permits a connection with a cloud system 18. Using the radio interface 16, the mobile terminal device 15 can control a testing process of the process chain 1, generate log records and transmit them via the radio interface 17 to the cloud system 18.

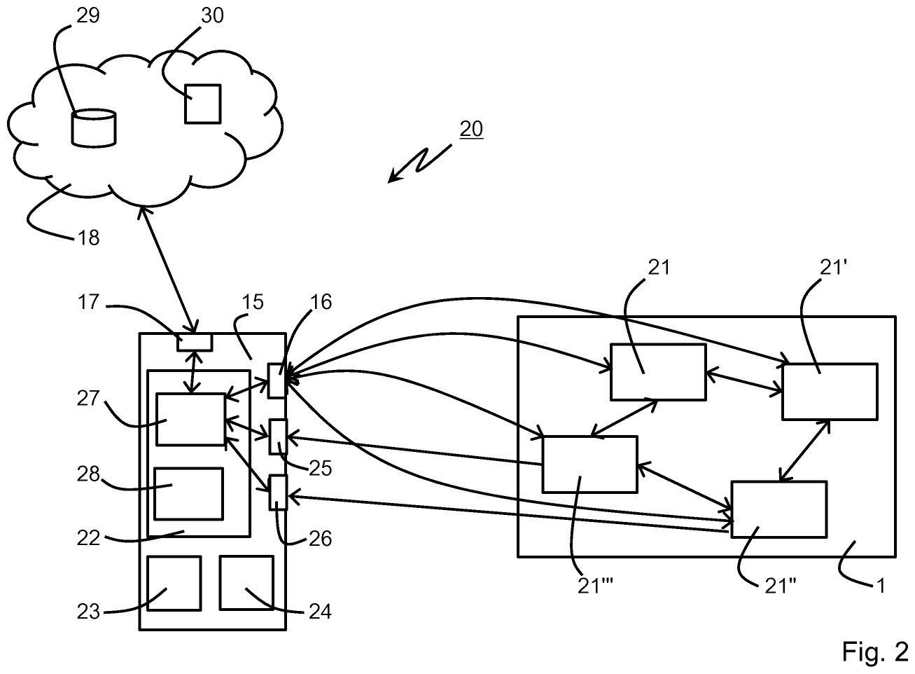

FIG. 2 shows a block diagram of a second exemplary embodiment of the system in which further details of the mode of operation of the system 20 are visible. The process chain 1 is reduced to four field devices 21, 21′, 21″ and 21′″, with a cooperation of the individual field devices being indicated by double-headed arrows and the field devices 21, 21′, 21″ and 21′″ being formed by measuring devices and/or actuators. The field devices 21, 21′, 21″ and 21′″ each have a radio interface via which a communication with the communication interface 16 of the mobile terminal device 15 is possible. The communication capability is indicated by means of double-headed arrows. In this case, communication is not required to take place in a direct connection. Rather, an intermediate station may also be interposed.

The mobile terminal device 15 includes a processor 22, a storage unit 23 (RAM or flash), input/output interface 24 as well as two recording devices 25, 26, which are configured as a camera and a microphone, respectively. The software, which implements at least a control unit 27 and a logging unit 28, is processed on the processor 22. Via the wide area interface 17, the mobile terminal device 15 can establish a connection with a cloud system 18 in which a storage unit 29 for storing log records and/or other data related to the testing process and an evaluation unit 30 are implemented.

In a testing process, the control unit 27 can control a test or simulation of the process chain 1, particularly of the field devices 21, 21′, 21″ and 21′″. In the process chain of FIG. 1, an overfilling or running dry of the container 5 can be provoked, for example, in order to recognize and assess a reaction of the process chain 1 to this situation. Instead of provoking a certain situation, this situation may also be simulated. When overfilling is simulated, a sensing element of the field device may, for example, be immersed in a separate container filled with filling material, so that the field device believes that it is measuring an overfilling of the container 5. Alternatively, the field device may also be caused to output a measurement value for overfilling or running dry, so that the behavior of the rest of the process chain can be examined for reaching a corresponding state.

During the testing process, the camera (recording device 25) records the field device 21′″, and the microphone (recording device 26) records the field device 21″. Both recording devices 25, 26 generate log records that can be transmitted to the cloud system 18 either directly or via the logging unit 28. The radio interface 17 is used in both cases. Log records received by the cloud system 18 are stored in the storage unit 29. The evaluation unit 30 can evaluate received log records. This evaluation may include a comparison of received log records with log records that were previously received for the same testing situation and the same field device, or a comparison of received log records with nominal courses. In this way, a deviating behavior and a possible need for maintenance can be recognized even better. This may include changes to the chronological sequence or unusual noise development, which may suggest wear or other malfunctions. An operator or third party may be informed of this in order to avoid unscheduled downtimes or even failures by preemptive maintenance.

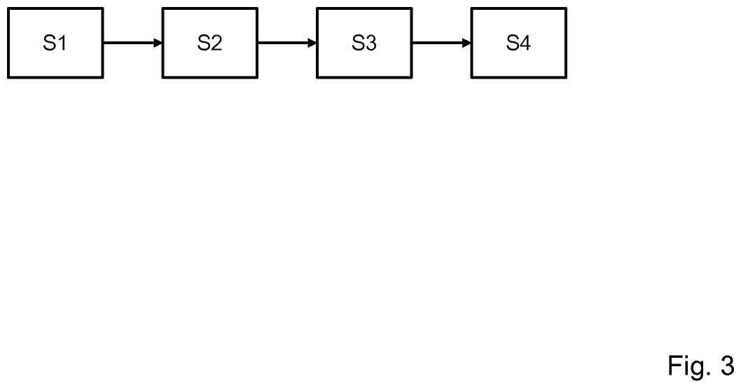

FIG. 3 shows a flow chart of an exemplary embodiment of a method according to the present disclosure. The method can be carried out in the context of a system as it is shown in FIG. 2, for instance. In step S1, at least one field device 21, 21′, 21″, 21′″ is controlled and/or data are read out, wherein the control or reading out are part of a testing process and can be carried out by the control unit 27. In step S2, the behavior of at least a part of the process chain 1, e.g. one or several of the field devices 21, 21′, 21″, 21′″, is recorded by means of at least one recording device 25, 26. In step S3, log records are generated, wherein the information recorded by the recording devices 25, 26 is used for this purpose. In step S4, the log records are stored, e.g. in the storage unit 29 of a cloud system 18. In addition, another step (not shown in FIG. 3) may be carried out, e.g. between the steps S2 and S3, in which the recorded information is evaluated by an evaluation unit 30. During this step, a current record can be compared with a record from an earlier testing process, for example, or a different previously described evaluation can be performed.

In order to avoid repetitions, reference is made to the general part of the description and to the attached claims with respect to other advantageous embodiments.

Finally, it is expressly pointed out that the above-described exemplary embodiments serve only for explaining the teaching disclosed herein, but that they do not limit it to the exemplary embodiments.

### REFERENCE SIGNS LIST

1 Process chain
2 Intake pipe
3 Electric motor (pump)
4 Pump
5 Tank
6 Electric motor (valve)
7 Valve
8 Outlet pipe
9 Filling material
10 Nominal level
11 Critical level
12 Limit level sensor
13 PLC control system
14 Radio waves
15 Mobile terminal device
16 Radio interface (short range)
17 Radio interface (wide area)
18 Cloud system
20 System
21 Field device
22 Processor
23 Storage unit
24 Input/output IF
25 Recording device (camera)
26 Recording device (microphone)
27 Control unit
28 Logging unit
29 Storage unit (log)
30 Evaluation unit

1. A system for testing a process chain in an industrial environment, wherein the process chain comprises at least one field device, the system comprising a control unit and a mobile terminal device,
wherein the control unit can be connected via a communication interface to the at least one field device in a communicating manner and is configured to control the at least one field device during a testing process and/or read out data via the communication interface,
wherein the mobile terminal device has at least one recording device, wherein the at least one recording device is configured for recording a behavior of at least a part of the process chain, and wherein the mobile terminal device is configured for generating, from information recorded by the at least one recording device, a log record of the at least one part of the process chain and storing said log record.

2. The system according to claim 1, wherein the at least one recording device includes a camera, a microphone, a temperature sensor, a pressure sensor, a gravity sensor, a magnetic field sensor and/or a vibration sensor.

3. The system according to claim 1, wherein the at least one recording device is integrated in the mobile terminal device or connected via a peripheral interface to the mobile terminal device.

4. The system according to claim 1, wherein the log record depicts at least an interval in time of the testing process.

5. The system according to claim 1, additionally comprising an evaluation unit, wherein the log record can be input into the evaluation unit and the evaluation unit is configured for evaluating an input log record.

6. The system according to claim 5, wherein the evaluation unit is configured for comparing an input log record with a log record of an earlier testing process and/or with a nominal course, and to issue a notification in case of a deviation beyond a threshold value.

7. The system according to a claim 1, additionally comprising a logging unit, wherein the logging unit is configured for generating a test log during the testing process based on control commands and/or measurement values of the at least one field device and/or their chronological order and/or the log record and/or based on other information.

8. The system according to claim 1, additionally comprising a cloud system, wherein the mobile terminal device is connected in a communicating manner to the cloud system and is preferably configured to transmit the log record into the cloud system in order to store the log record.

9. The system according to claim 8, wherein the evaluation unit is implemented in the cloud system.

10. The system according to claim 1, wherein the control unit is implemented in the mobile terminal device.

11. The system according to claim 1, wherein the control unit is configured for setting and/or controlling a starting time for the recording by the at least one recording device and/or the duration of the recording.

12. The system according to claim 1, wherein the communication interface is formed by a wireless interface, preferably for a short-range communication or a wide area communication.

13. A method for testing a process chain in an industrial environment, wherein the process chain comprises at least one field device, the method comprising:
controlling and/or reading out data (S1) of the at least one field device during a testing process by means of a control unit,
recording (S2) a behavior of at least a part of the process chain by at least one recording device,
generating (S3) a log record based on information of the at least one part of the process chain recorded by the at least one recording device, and
storing (S4) the log record.

14. The method according to claim 13, wherein the log record is stored together with a time stamp and/or with measurement values of the at least one field device and/or with control information for the at least one field device and/or status information of the process chain.

15. A computer program product which, when executed on a mobile terminal device, is configured for making a mobile terminal device usable in a for testing a process chain in an industrial environment, wherein the process chain comprises at least one field device, by the steps of:
controlling and/or reading out data of the at least one field device during a testing process,
recording a behavior of at least a part of the process chain,
generating a log record based on information of the at least one part of the process chain recorded by the at least one recording device, and
storing the log record.
